(19) United States
(12) Patent Application Publication
(10) Pub. No.: US 2008/0310155 A1
(43) Pub. Date: Dec. 18, 2008

(54) LED LIGHTING DEVICE

(75) Inventors: Heng-Chun Huang, Taipei (TW); Chien-Hua Liu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 12/131,939

(22) Filed: Jun. 3, 2008

(30) Foreign Application Priority Data
Jun. 13, 2007 (TW) 96121291

(51) Int. Cl. F21V 9/00; F21V 1/00; F21V 21/00

(52) U.S. Cl. 362/231; 362/235; 362/249

(57) ABSTRACT

An LED lighting device is disclosed. The LED lighting device includes a lampshade, a circuit board, edge lighting light emitting diodes (LEDs), and an optical film set. The lampshade has a bottom and a side wall connected to the periphery of the bottom. The other end of the side wall opposite to the bottom defines a light outlet section. The circuit board is provided at the lampshade. The edge lighting LEDs are disposed on the bottom of the lampshade and are electrically connected to the circuit board. Light emitted from each of the edge lighting LEDs is reflected by the lampshade and then exits the lighting device through the light outlet section. The optical film set is disposed at the light outlet section of the lampshade.

### CROSS-REFERENCE TO RELATED APPLICATION

This application claims the priority benefit of Taiwan application serial no. 96121291, filed on Jun. 13, 2007. The entirety of the above-mentioned patent application is hereby incorporated by reference herein and made a part of specification.

### BACKGROUND OF THE INVENTION

1. Field of the Invention

The invention relates to a lighting device and, more particularly, to a light emitting diode (LED) lighting device with edge lighting LEDs as its light source.

2. Description of the Related Art

Since a light emitting diode (LED) has a long service life and consumes a little power, it has been used more and more popularly. For example, it has been used in the electronic panel of a large display, traffic light, direction lamp and personal table lamp and so on. Nowadays, the LED is developed to have high brightness, low light loss to enable the LED to replace the conditional lighting tools. In addition, the LED will be gradually used in LED projecting light source with a high brightness in the future. For example, it may be used in digital light processing (DLP) projector, liquid crystal display (LCD) projector and other new type of colorful optical projector with a high brightness.

The conditional LED lighting device mainly includes a red LED, a green LED and a blue LED. After the red light, green light and blue light emitted by the red LED, green LED and blue LED are mixed, the white light is outputted.

Nowadays, the LED lighting device mainly uses Lambertian type LED which emits the light forward directly and has concentrated light energy. However, the lighting device composed of the Lambertian type LEDs has the following problems. First, since the Lambertian type LED projects light directly, the light is blinding, and the LED can be seen obviously one by one. The brightness is high, and the LED glares, especially when it is used in a table lamp. Second, LEDs with different colors emit light forward directly, and therefore, a large light mixing area is needed to harmonize the light. Thus, the size of the whole LED lighting device is increased, which causes inconvenience.

### BRIEF SUMMARY OF THE INVENTION

The invention provides an LED lighting device. When the LED lighting device has enough illumination, the brightness thereof decreases to meet the demand of the low glare of the table lamp. Then, a user can use the LED lighting device comfortably. In addition, since the room for mixing light and mixing color is small in the LED lighting device in the invention, it helps the LED lighting device to be slim.

The invention provides an LED lighting device including a lampshade, a circuit board, a plurality of edge lighting LEDs and an optical film set. The lampshade has a bottom and a side wall connected to the periphery of the bottom. The other end of the side wall opposite to the bottom defines a light outlet section. The circuit board is provided at the lampshade. The edge lighting LEDs are provided at the bottom of the lampshade and electrically connected to the circuit board. The edge lighting LEDs emit light. The lampshade reflects the light and enables the light to be emitted from the light outlet section. The optical film set is provided at the light outlet section of the lampshade.

In one embodiment of the invention, the circuit board is provided outside the lampshade. The bottom of the lampshade has a plurality of holding holes, and each edge lighting LED is disposed in the corresponding holding hole, respectively, to be electrically connected to the circuit board.

In one embodiment of the invention, the circuit board is disposed in the lampshade and at the bottom of the lampshade.

In one embodiment of the invention, the LED lighting device further includes a reflecting layer disposed on the circuit board. The reflecting layer exposes the edge lighting LEDs.

In one embodiment, the LED lighting device further includes a reflecting cover disposed in the lampshade. The reflecting cover covers the side wall and the circuit board. The reflecting cover has a plurality of holding holes, and each edge lighting LED is disposed in the corresponding holding hole, respectively, to be electrically connected to the circuit board.

In one embodiment of the invention, the edge lighting LEDs include red LEDs, blue LEDs and green LEDs.

In one embodiment of the invention, the optical film set includes Fresnel lens, Prism sheet, Lenticular lens, Micro lens array, diffuser or the combination thereof.

The LED lighting device of the invention mainly utilizes the edge lighting LEDs as its light source. After the light emitted by the edge lighting LEDs is reflected by the lampshade (or the reflecting cover), gathered or mixed by the optical film set, it is emitted from the light outlet section. The spot light source is converted into area light source by the above structure. When the LED lighting device has enough illumination, the brightness decreases to enable the LED lighting device to meet the demand of low glare. Then, a user can use the LED lighting device comfortably.

In addition, since the LED lighting device of the invention does not need a large room for mixing light and color, it helps the LED lighting device to be slim.

These and other features, aspects, and advantages of the present invention will become better understood with regard to the following description, appended claims, and accompanying drawings.

### BRIEF DESCRIPTION OF THE DRAWINGS

FIG. 1 is a section schematic diagram showing a light emitting diode (LED) lighting device according to one embodiment of the invention.

FIG. 2 is a section schematic diagram showing an LED lighting device according to another embodiment of the invention.

FIG. 3 is a section schematic diagram showing an LED lighting device according to another embodiment of the invention.

### DETAILED DESCRIPTION OF THE EMBODIMENTS

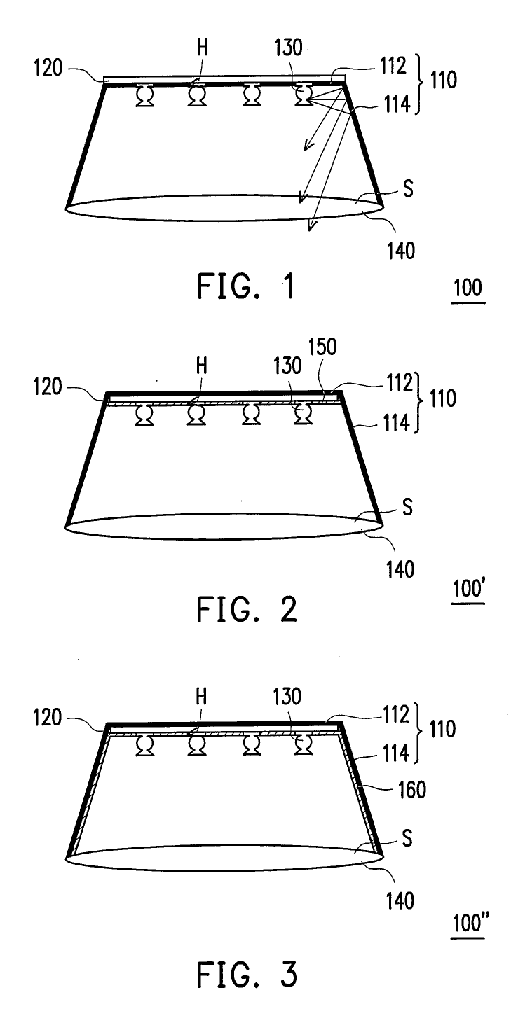

FIG. 1 is a section schematic diagram showing an LED lighting device according to an embodiment of the invention. The lighting device 100 of the invention mainly includes a lampshade 110, a circuit board 120, a plurality of edge lighting light emitting diodes (LEDs) 130 and an optical film set 140. Each component of the lighting device 100 and the relationships thereof are described with appended drawings hereinbelow.

The lampshade 110 has a bottom 112 and a side wall 114 connected to the periphery of the bottom 112. The other end of the side wall opposite to the bottom 112 defines a light outlet section S. In the embodiment, the lampshade 110 is made of material with a high reflectivity such as metal, or the inner surface of the lampshade 110 is coated to be white to reflect the light. The circuit board 120 is disposed on the lampshade 110 to drive the edge lighting LEDs 130. The plurality of edge lighting LEDs 130 are disposed at the bottom 112 of the lampshade 110. In the embodiment, the circuit board 120 is disposed outside the lampshade 110. In addition, the bottom 112 of the lampshade 110 has a plurality of holding holes H, and each of the edge lighting LEDs 130 is disposed in the corresponding holding hole H, respectively, to be electrically connected to the circuit board 120.

The difference between the edge lighting LED and the conventional Lambertian type LED is that the edge lighting LED emits the light sideward (the emitting angle is 60 degree to 100 degree). Therefore, after the light emitted by the edge lighting LEDs 130 sideward is reflected by the lampshade 110, it is emitted from the light outlet section S. An optical film set 140 is provided at the light outlet section S to gather or mix the light. The optical film set 140 includes Fresnel lens, Prism sheet, Lenticular lens, Micro lens array, diffuser or the combination thereof.

After the light emitted by the edge lighting LEDs 130 sideward is reflected by the lampshade 110, mixed in the lampshade 110, gathered or mixed by the optical film set 140, the spot light source is converted into the area light source. Then, when the lighting device 100 has enough illumination, the brightness decreases, and the lighting device can meet the demand of low glare.

In one embodiment of the invention, the edge lighting LEDs 130 includes the red LEDs, blue LEDs and green LEDs. After the red light, blue light and green light emitted by the red LEDs, blue LEDs and green LEDs are mixed, the white light is emitted.

FIG. 2 is section schematic diagram showing an LED lighting device according to another embodiment of the invention. In the LED lighting device 100′, the circuit board 120 is disposed in the lampshade 110 and at the bottom 112 of the lampshade 110. If the light is emitted on the circuit board 120, it cannot be used anymore. To prevent this problem, a reflecting layer 150 is disposed on the circuit board 120 to effectively reflect the light to the side wall 114 of the lampshade 110 or the light outlet section S.

FIG. 3 is a section schematic diagram showing an LED lighting device according to another embodiment of the invention. In the LED lighting device 100″, the circuit board 120 is also disposed at the bottom 112 of the lampshade 110. The difference between the lighting device 100″ and the lighting device 100′ shown in FIG. 2 is that a reflecting cover 160 is directly disposed in the lampshade 110 of the lighting device 100″. Furthermore, the reflecting cover 160 is disposed in the lampshade 110 to cover the side wall 114 and the circuit board 120. The reflecting cover 160 has a plurality of holding holes H, and each of the edge lighting LEDs 130 is disposed in the corresponding holding hole H, respectively, to be electrically connected to the circuit board 120.

To sum up, the LED lighting device of the invention mainly utilizes the characteristic that the edge lighting LED emits light sideward, the lampshade (or the reflecting cover) and the optical film set. After the light emitted by the edge lighting LEDs is reflected by the lampshade (or the reflecting cover), gathered and mixed by the optical film set, it is emitted from the light outlet section. The spot light source can be converted into the area light source by the above structure. When the LED lighting device has enough illumination, the brightness decreases to meet the demand of low glare. Then, a user can use the LED lighting device comfortably.

In addition, compared with the conventionally used Lambertian type LED lighting device, the LED lighting device of the invention does not need a large room for mixing light and color, which helps the LED lighting device to be slim.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An LED lighting device comprising:
a lampshade having a bottom and a side wall connected to the periphery of the bottom, wherein the other end of the side wall opposite to the bottom defines a light outlet section;
a circuit board provided at the lampshade;
a plurality of edge lighting LEDs disposed at the bottom of the lampshade and electrically connected to the circuit board, wherein each of the edge lighting LEDs emit light, and the lampshade reflects the light to enable the light to be emitted from the light outlet section; and
an optical film set disposed at the light outlet section of the lampshade.

2. The LED lighting device according to claim 1, wherein the circuit board is disposed outside the lampshade, the bottom of the lampshade has a plurality of holding holes, and each of the edge lighting LEDs is disposed in the corresponding holding hole, respectively, to be electrically connected to the circuit board.

3. The LED lighting device according to claim 1, wherein the circuit board is provided in the lampshade and at the bottom of the lampshade.

4. The LED lighting device according to claim 3, further comprising a reflecting layer which is disposed on the circuit board and exposes the edge lighting LEDs.

5. The LED lighting device according to claim 3, further comprising a reflecting cover disposed in the lampshade to cover the side wall and the circuit board, wherein the reflecting cover has a plurality of holding holes, and each of the edge lighting LED is disposed in the corresponding holding hole, respectively, to be electrically connected to the circuit board.

6. The LED lighting device according to claim 1, wherein the edge lighting LEDs comprises red, blue and green LEDs.

7. The LED lighting device according to claim 1, wherein the optical film set comprises Fresnel lens, Prism sheet, Lenticular lens, Micro lens array, diffuser or the combination thereof.
